(19) United States
(12) Patent Application Publication
(10) Pub. No.: US 2013/0118667 A1
(43) Pub. Date: May 16, 2013

(54) PNEUMATIC VEHICLE TIRE

(71) Applicant: Continental Reifen Deutschland GmbH, Hannover (DE)

(72) Inventors: Wolfgang Reese, Peine (DE); Sadettin Fidan, Garbsen (DE)

(73) Assignee: Continental Reifen Deutschland GmbH, Hannover (DE)

(21) Appl. No.: 13/739,639

(22) Filed: Jan. 11, 2013

Related U.S. Application Data
(63) Continuation of application No. PCT/EP2011/060083, filed on Jun. 17, 2011.

(30) Foreign Application Priority Data
Jul. 30, 2010 (DE) 10 2010 036 760.5

(51) Int. Cl. B60C 9/18

(52) U.S. Cl. CPC B60C 9/18
USPC 152/527

(57) ABSTRACT

A pneumatic vehicle tire of a radial design, having a tread, a radial carcass, a belt structure with at least two belt plies and with at. least one belt bandage layer, which is arranged radially outside the. belt and is formed by continuously winding a PBT cord in a helical shape in the circumferential direction of the tire. The PET cord has an extension of 3% to 5% given a force of 1.56 cN/dtex at 20° C., and an extension of 7% to 9% at 160° C. The sum of the elongation at tear of the PET cord and the thermal shrinkage determined at 180° C., and with a pretensioning force of 0.01 cN/dtex and a duration of action of two minutes, is greater than 20%.

### CROSS REFERENCE TO RELATED APPLICATIONS

This application is a continuation application of international patent application PCT/EP2Q11/060083, filed Jun. 17, 2011, designating the United States and claiming priority from German application 10 2010 036 760.5, filed Jul. 30, 2010, and the entire content of both applications is incorporated herein by reference.

### FIELD OF THE INVENTION

The invention relates to a pneumatic vehicle tire of a radial design, with a tread, a radial carcass, a belt assembly with at least two belt plies and with at least one belt bandage ply, which is arranged radially outside the belt: and is formed by continuously and spirally winding a PFT cord, in the circumferential direction of the tire.

### BACKGROUND OF THE INVENTION

Such a pneumatic vehicle tire is known, for example, from U.S. Pat. No. 7,584,774. A PET cord which has a modulus of elasticity of no less than 2.5 mN/dtex % under a load of 29.4 M, measured at 160° C., is used for the bandage plies. In addition, the cord is treated, with an adhesion-improving composition, which comprises a thermoplastic polymer, a heat-curable, aqueous polyurethane resin and an epoxy resin compound. It is also customary to use nylon cords, in particular PA 6.6, in the bandage plies of a pneumatic vehicle tire. Because of the comparatively low tensile modulus of nylon cords, it is necessary for certain applications, in particular if the high-speed durability of the tire is of significance, to provide two bandage plies with nylon cords as reinforcing elements. The main task of bandage plies in tires is to prevent relative movements at the lateral, belt ply edges, in order to avoid separation of the belt ply edges.

### SUMMARY OF THE INVENTION

The invention is based on the object of providing a PET cord for the bandage ply (plies) that ensures even in the possible case of s single-ply configuration of the bandage that the tire has good high-speed durability, a long service life and reduced flat spotting.

The object is achieved according to the invention by the PET cord having under a force of 1.56 cN/dtex an extension of 3% to 5% at 20° C. and an extension of 7% to 9% at 160° C., the sum of the elongation at break of the PET cord and the thermal shrinkage, determined at 180° C., under a pretensioning force of 0.01 cH/dtex and with a duration of action of two minutes, being greater than 20%, and by the PET cord having a. thermal shrinkage, determined at 180° C., under a pretensioning force of 0.01 cN/dtex and with a duration of action of two minutes, greater than 2.5%.

A bandage ply provided with such a PET cord in the pneumatic vehicle tire effectively prevents belt edge separation, ensures good high-speed durability and a long service life of the tire, and reduces flat spotting.

Some cord parameters are particularly essential for helping to achieve these effects. Of importance for example is the total fineness of the cord; the PET cord according to the invention should have a total fineness of between 1000 dtex and 6000 dtex, in particular between 1000 dtex and 2000 dtex. Furthermore, the PET cord should have a cord twist of between 80 tpm and 500 tpm, in particular between 250 tpm and 400 tpm.

In the case of a configurational variant, the PET cord according to the invention, consists of a single yarn. In the case of alternative embodiments, the PET cord is made up of a number of yarns.

An arrangement of the PET cord according to the invention in the bandage ply with 60 epdm to 120 epdm, in particular with 80 epdm to 100 epdm, has proven to be particularly favorable for the prevention of a separation of the belt ply edges, for good high-speed durability and a long service life of the tire. Only a single bandage ply is required in this case.

### BRIEF DESCRIPTION OF THE DRAWING

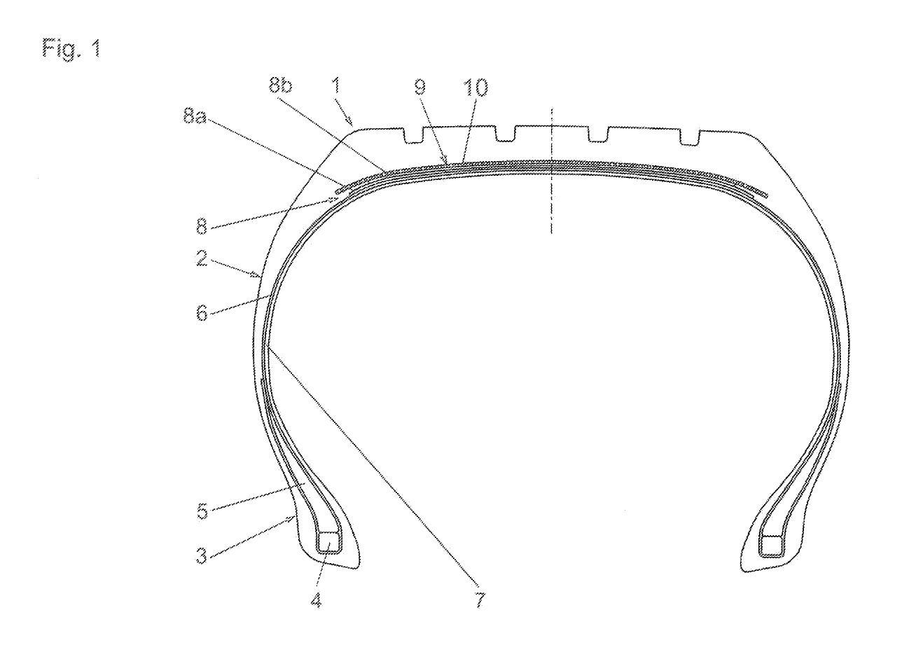

The invention will now be described with reference to the single figure of the drawing (FIG. 1) which schematically shows a cross section through a pneumatic vehicle tire.

### DESCRIPTION OF THE PREFERRED EMBODIMENTS OF THE INVENTION

The pneumatic vehicle tire shown in FIG. 1 is a tire for passenger cars of a radial design and has a tread 1, sidewalls 2, bead regions 3 with bead cores 4 and bead profiles 5, also a carcass ply 6, which runs around the two bead cores 4, an inner-layer 7 and a belt assembly 8 arranged between the carcass ply 6 and the tread 1. In the case of the embodiment shown, the belt assembly 8 has two belt plies 8a and 8b, which in a known way may consist of reinforcing elements of steel cord running parallel to one another and embedded in a rubber compound. The steel cords in the one belt ply 8a run crosswise in relation to the steel cords in the other belt ply 8b and form with the circumferential direction of the tire one of the customary angles of the order of. magnitude of 20° to 25°. Radially outside the two belt plies (8a, 8b) there is a bandage ply 9—a cap ply—which is formed by continuously and spirally winding a cord 10 of PET (polyethylene terephthalate) in the circumferential direction of the tire and covering over the lateral outer edges of the belt assembly 8.

According to the invention, a PET cord 10 that has the following properties is used. Under the action of a force of 1.56 cN/dtex, the extension of the cord 10 at a temperature of 20° C. is between 3% and 5%, at a temperature of 160° between 7% and 9%. Under a pretensioning force of 0.01. cN/dtex acting over a time period of two minutes and at a temperature of 180° C., the sum of the elongation at break and the thermal shrinkage is greater than 20%. Furthermore, the thermal shrinkage at 180° C. and under the action of a pretensioning force of 0.01 cN/dtex, with a duration of action of two minutes, is greater than 2.5%.

The PET cord 10 according to the invention may consist of one or more yarns and has a total fineness of between 1000 dtex and 6000 dtex, in particular up to 2000 dtex. In particular, a PET cord 10 of one yarn with a cord twist of between 80 and 500 tpm (turns par meter), in particular between 250 tpm and 400 tpm, is used.

The mutual spacing when winding the PET cord 10 to form the belt bandage is set in such a way that there are between 60 and 120 epdra (ends per decimeter) in the finished bandage ply. In the case of a preferred embodiment of the invention, the bandage ply 9 has between 80 epdra and 100 epdm.

A tire with a single bandage ply 9 configured according to the invention has a high-speed durability that is comparable with tires with known two-ply configurations of the bandage with nylon 6.6 as the; reinforcing element. A further advantageous effect of the bandage ply according to the invention is the better absorption of loads acting with a shock-like effect, without there being the risk of cord ruptures in the belt plies. In comparison with the customarily used nylon cords, flat spotting (a temporary deformation of the footprint of the tire during parking) is significantly reduced in the case of the tire configured according to the invention.

Tires of the size 200/55 R16 91W with a two-ply nylon bandage ply were compared with tires of the same size with a single-ply bandage of PET cord 10 according to the invention. In the case of the tires according to the prior art, the bandage plies had cords of nylon 6.6, structure 940×2, arrangement with 80 epdm. The tires according to the invention had a single bandage ply with a PET cord 10 configured according to the invention, structure 1440×2, configured with 100 epdm. In the following Table 1, the test results are compiled. Determined or tested were the service life, high-speed durability, flat spotting, rolling resistance and stiffness when traveling around bends. Furthermore, the production costs of the bandage plies were compared with one another. The test results determined with the tires according to the prior art were set at 100; the improvement achieved with the tires according to the invention are evident in a value greater than 100, for example the value indicated in Table 1. for flat spotting of 115 meaning that the tires according to the invention were 15% better.

TABLE 1

| | PA 6.6, 940x2, | PET, 1440x2, |
|---|---|---|
| | 80 epdm | 100 epdm |
| | two-ply | one-ply |
| Service life | 100 | 100 |
| High-speed | 100 | 100 |
| durability | | |
| Flat spotting | 100 | 115 |
| Rolling | 100 | 104 |
| resistance | | |
| Stiffness around | 100 | 105 |
| bends | | |
| Costs of the | 100 | 135 |
| bandage | | |

It is under-stood that the foregoing description is that of the preferred embodiments of the invention and that various changes and modifications may be made thereto without departing from the spirit and scope of the invention as defined in the appended claims.

### LIST OF DESIGNATIONS

1 . . . Tread
2 . . . Sidewall
3 . . . Bead region
4 . . . Bead core
5 . . . Bead profile
6 . . . Carcass ply
7 . . . Inner layer
8 . . . Belt assembly
8a . . . Belt ply
8b . . . Belt ply
9 . . . Bandage ply
10 . . . PET cord

What is claimed is:

1. A pneumatic vehicle tire of a radial, design comprising;
a tread;
a radial carcass; and
a belt assembly with at least two belt plies and with at least one belt bandage ply, which is arranged radially outside the belt and is formed by continuously and spirally winding a PET cord, in a circumferential direction of the tire;
the PET cord having under a force of 1.56 eN/dtex an extension of 3% to 5% at 20° C. and an extension of 7% to 9% at 160° C.,
the sum of the elongation at break of the PET cord and the thermal shrinkage, determined at 180° C., under a pretensioning force of 0.01 cN/dtex and with a duration of action of two minutes, being greater than 20%,
and the PET cord having a thermal shrinkage, determined at 180° C., under a pre tensioning force of 0.01 cN/dtex and with a duration of action of two minutes, greater than 2.5%.

2. The pneumatic vehicle tire as claimed in claim 1, wherein the PET cord has a total fineness of between 1000 dtex and 6000 dtex.

3. The pneumatic vehicle tire as claimed in claim 1, wherein the PET cord has a cord twist of between 80 tpm and 500 tpm.

4. The pneumatic vehicle tire as claimed in claim 1, wherein the PET cord consists of a single yarn.

5. The pneumatic vehicle tire as claimed in claim 1, wherein the PET cord is arranged in the bandage ply with 60 epdm to 120 epdm.

6. The pneumatic vehicle tire as claimed in claim 2, wherein the PET cord has a total fineness of between 1000 dtex and 2000 dtex.

7. The pneumatic vehicle tire as claimed in claim 3, wherein the PET cord has a cord twist of between 250 tpm and 400 tpm.

8. The pneumatic vehicle tire as claimed in claim 5, wherein the PET cord is arranged in the bandage ply with 80 epdm to 100 epdm.
